(19) United States
(12) Patent Application Publication
(10) Pub. No.: US 2026/0347520 A1
(43) Pub. Date: Nov. 5, 2026

(54) Novel Cross-Linking Agent for Rubber and Process for its Preparation

(71) Applicant: NOCIL LTD., Mumbai (IN)

(72) Inventors: Chinmoy Nandi, Mumbai (IN); Narendra Digambar Gangal, Mumbai (IN); Prahlad Laxman Rao, Mumbai (IN); Ganesh Nagesh Kamath, Mumbai (IN); Vikas Sudam Padalkar, Mumbai (IN)

(21) Appl. No.: 19/488,936

(22) PCT Filed: May 7, 2024
(86) PCT No.: PCT/IB2024/054432

§ 371 Date: Dec. 1, 2025

(30) Foreign Application Priority Data
Jun. 19, 2023 (IN) 202321041451

(51) Int. Cl. C08F 212/08; C08F 2/18; C08K 3/06

(52) U.S. Cl. CPC C08F 212/08; C08F 2/18; C08K 3/06

(57) ABSTRACT

The present invention relates to novel sulfur-olefin adduct as useful rubber cross-linking agent with better mixing performance in rubber & provide a vulcanized rubber composite with improved dynamic physical properties. The present invention further relates to a process for preparation of novel sulfur-olefin adduct comprising of reacting sulfur with olefinic compounds in the presence of catalyst.

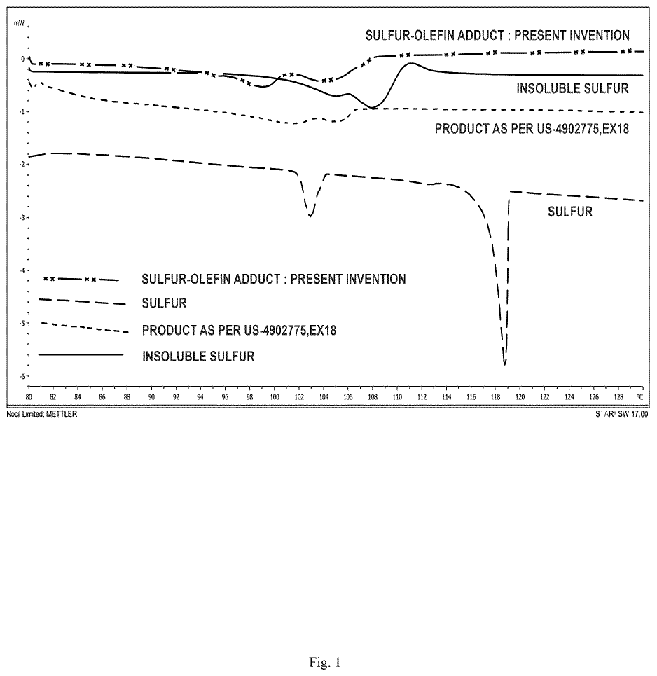

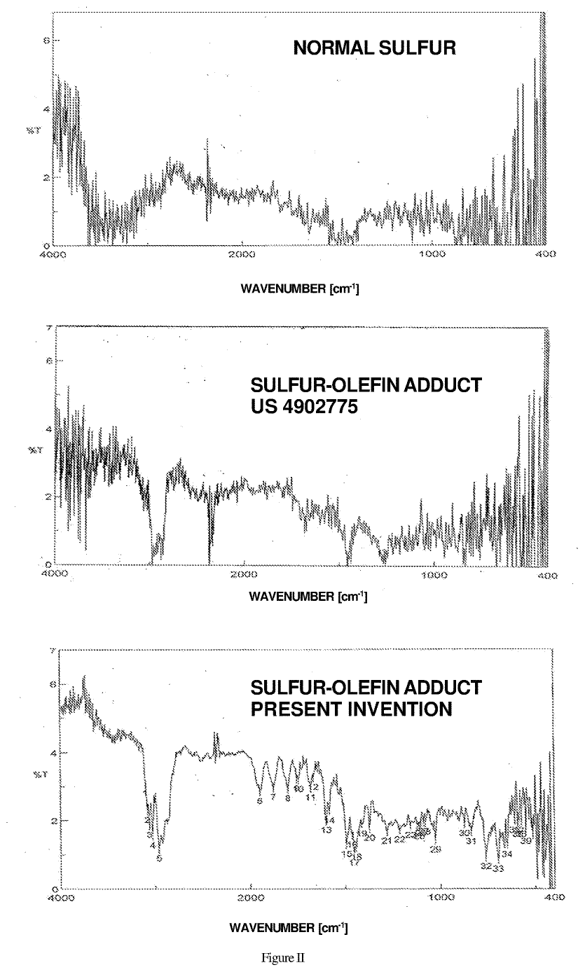

### FIELD OF THE INVENTION

The present invention relates to rubber crosslinking agent, in particular to novel sulfur-olefin adduct which is used as cross-linking agent in manufacture of natural and/or synthetic rubber articles. The present invention further relates to a novel sulfur-olefin adduct, which is prepared through a special catalytically controlled polymerization process comprising of reacting sulfur with olefins to form sulfur-olefin adduct and exhibits superior performance & product form, as a crosslinking agent. The invention specifically relates to a process of catalytically controlled inverse vulcanization of sulfur such that the final sulfur-olefin adduct exhibits better physical properties in terms of heat stability & product form and when incorporated in rubber shows better properties in terms of faster dispersion in rubber, bloom resistance, dynamic physical properties & other cure characteristics.

### BACKGROUND OF THE INVENTION

Vulcanization is a process where sulfur is used to form a three-dimensional rubber network via chemical crosslinking between the linear macromolecules of natural or synthetic rubbers and the curing agent sulfur, so as to increase elasticity of rubber, which allows practical applications of rubber goods.

Efficient vulcanization process requires incorporation of a relatively high amount of sulfur. However, rubber containing high sulfur may exhibit an undesirable sulfur migration effect from the bulk to their surface, commonly known as “bloom”. Sulfur shows a tendency to bloom onto rubber surface when its concentration exceeds maximum solubility in the rubber at storage temperature. This causes decrease of tack at the surface of the rubber stock and is likely to adversely affect, for example, a tire forming process in which rubber compound tackiness plays a very important role.

There are two types of sulfur commonly used in rubber industry: elemental sulfur (rubber soluble) having S₈ ring structure and Polymeric (rubber insoluble) sulfur having long chain polysulfidic macromolecules called as Insoluble sulfur. Insoluble sulfur was developed to overcome the problem of bloom in rubber processing which is a very critical problem in the Tire manufacture industry. Insoluble sulfur is usually prepared by rapidly quenching molten sulfur above 159 °C (preferably >250 °C) or vaporized Sulfur at >600 °C in Carbon disulfide (CS₂) solvent at ambient temperature. The processes commonly used to produce polymeric sulfur (Insoluble sulfur) is particularly not attractive due to high energy-intensive process and safety hazard due to high flammability of CS₂. Therefore, the current manufacturing process poses not only technical and engineering problems, but also enormous safety problems due to extremely high flammability of CS₂. Insoluble sulfur product consists primarily of long-chain sulfur molecules and a lesser amount of soluble S₈ rings.

Insoluble sulfur is a better vulcanizing agent than Rhombic sulfur (conventional Rubber grade Sulfur) but does not provide a complete solution to the problem of blooming. There is a tendency for the long chain molecules of Insoluble sulfur to revert to the more stable soluble form if exposed to higher cure temperatures, long storage time, etc. Reversion of insoluble sulfur to soluble sulfur partially either before or after it is compounded into a rubber composition, results in blooming due to soluble sulfur solubility in rubber beyond saturated level at a given temperature. Also, rubber compositions are prone to scorching if processed at an unduly high temperature.

Consequently, a crosslinking agent which can be prepared Industrially with ease & can be handled easily during addition to Mixing devices for compounding viz. Banbury mixer, Two Roll mill etc. & also provides reduced blooming and better physical & cure properties in rubber composite, is desirable in the rubber industry. Many prior art literature teach use of a copolymers of sulfur with an unconjugated diene, which is believed to enhance the compatibility with the rubber. The polymeric structure is also supposed to improve the stability of the sulfur chains against breakdown to soluble S₈ units at normal storage and processing temperatures & yet readily allow the release of sulfur for crosslinking at vulcanizing temperatures.

U.S. Pat. No. 2,989,513A teaches a method of preparation of a vulcanizing agent which comprises heating together at a temperature from 145-180 °C almost 1:1 part by weight of Sulfur & the olefin to obtain a viscous liquid.

U.S. Pat. No. 3,259,598 discloses a method of preparing a vulcanizing agent comprising heating Sulfur, Linseed oil & styrene at temperature 128-135 °C for 5-50 hours to yield a friable interpolymer, which had to be pulverized before use in rubber. Similarly, U.S. Pat. No. 3,264,239A discloses an interpolymer made by heating Sulfur, Linseed oil & Dicyclopentadiene (DCPD) as above.

U.S. Pat. No. 3,523,926 discloses vulcanizing agents from diolefins such as cyclopentadiene and dicyclopentadiene, and sulfur with amines as catalyst at 140 °C; however, the isolation of the product from the reaction mass is done by dissolving the product in CS₂ and evaporating the CS₂.

U.S. Pat. No. 4,902,775 & U.S. Pat. No. 4,739,036 discloses a vulcanizing agent which is prepared by heating together with agitation at a temperature of from 120°-200 °C between 1 and 50 parts by weight of sulfur and 1 part by weight of an olefin or olefins in an aqueous reaction media in the presence of a base and a dispersing agent. The product is obtained in the form of beads of various sizes.

WO1999048966A1 highlights the disadvantages of the product obtained from the process described in U.S. Pat. No. 4,739,036 as being not optimally suited for incorporation into the rubber compound due to the relatively large granular product and describes process equipment to obtain product with a specific particle size distribution, with 90 weight % of the composition particulates have a particle size of not more than 20 microns.

U.S. Pat. No. 6,747,122B2 describes the process for preparation of polymeric sulfur with polythiocyclopentanediyl at 140 °C and 70 bar pressure in presence of amine as catalyst and H₂S.

Recently, there has been a lot of studies directed towards a process called “Inverse Vulcanization” (i.e., polymerization of Sulfur by adding small amount of olefins, contrary to adding small amount of sulfur in unsaturated rubber to get vulcanized rubber in conventional vulcanization), the term proposed by J. Pyun & Chung, in “Nature Chemistry, 2013 DOI: 10.1038/NCHEM.1624” describing the process to prepare chemically stable and processable polymeric materials through the direct copolymerization of elemental sulfur with vinylic monomers” & produce polymers containing chains of Sulfur atoms wherein the sulfur atoms are bridged together with small dienes/olefins or longer organic molecules.

Jakub Wręczycki et al described in one conference paper (2018), at IX International Scientific-Technical Conference “Advance in Petroleum and Gas Industry and Petrochemistry” (APGIP-9), Sulfur/Organic Copolymers as Curing Agents for Rubber, the utilization of such products as vulcanizing agents in rubber. However, these products which are synthesised in a bulk polymerization technique without any solvent & are obtained as a hard solid mass, difficult to isolate from the reactor and hence poses problem of scaling up the process to commercial scale.

In a study by Ronaldo P Parreño Jr et al, 2020 IOP Conf. Ser.: Mater. Sci. Eng. 778 012023, titled “Sulfur copolymers (S-DIB) from inverse vulcanization of elemental sulfur (S₈) for polymer blend” it was found that the sulfur copolymers structural evolution involved branched to hyper-branched, as comonomer DIB (Di Isopropenyl Benzene) increase. For S-DIB with higher sulfur content (90 Weight %), the copolymers structure comprised of longer polysulfide loops while higher DIB ratio (20-50 Wt %) produced copolymers with hyper-branched structure. Inverse-vulcanization is relatively recent trend and extensive investigation is still on to provide a detail mechanism as highlighted by the Hassel group in “NATURE COMMUNICATIONS|(2019) 10:64”. Most of the existing discussion describes inverse vulcanization as being bulk free radical copolymerization of unsaturated co-monomers with liquid sulfur and proposed addition of sulfur diradical across the olefins double bonds as well as partial abstraction of alpha-hydrogen and generation of H₂S.

From a review of the prior art disclosures (patents & the recent Literature references) for preparing sulfur-olefin adducts, it is apparent that the reaction product of sulfur and an olefin/olefins gives products that are viscous liquids or hard solids that stick to the reactors & are difficult to handle even at lab scale & pose much higher difficulties on an industrial scale. Also, the product from this reaction mixture must be pulverized before it can be incorporated into the rubber elastomer due to the physical properties and the physical form of the sulfur-olefin adduct. Besides, sulfur-olefin adducts made by earlier methods quite often are not easily dispersed in rubber matrix during compounding. These are the disadvantages of the aforementioned processes for commercial scale-up.

In order to economically produce large quantities of vulcanizable rubber compositions required in the tire and rubber specialties industries, it is becoming important to use automated methods & device systems and strict time schedules in the transport/conveying of the sulfur & other ingredients, for mixing and other operations used in preparing the rubber vulcanizable compositions. To pursue adherence to these time schedules, the component materials of the vulcanizable compositions must meet certain strict criteria in respect to speed and ease of transport/conveying & uniform incorporation into the rubber compounds. At present addition of normal sulfur or Insoluble sulfur in powder form to the internal mixing devices poses difficulty, due to their difficult flowability into mixing devices. Besides, sticking of powder sulfur (both rubber grade and Insoluble sulfur) to the mixing equipment poses further problem in mixing of the compound.

In some cases, Polymer bound sulfur in pellet form, is used which is expensive and require higher dosage level to compensate polymer content.

The inventors of the present invention have surprisingly found that the above disadvantages and problems can be overcome through the present invention which provides a novel sulfur-olefin adduct comprising of sulfur and polymeric sulfur wherein such novel sulfur-olefin adduct, is prepared by catalytic suspension polymerization of sulfur and olefins at 160°-170 °C under agitation in water, in presence of a base and a dispersing agent and adding a catalyst within narrow dosage range to control the sulfur polymerization and hold at the desired temperature for a period of 1 to 24 hours, to obtain a product which is a mixture of sulfur-olefin adduct and sulfur, as a free flowing powder/granular product, which is easily incorporated in rubber and comparatively less fall through in two roll mill type mixing system.

### OBJECT OF THE INVENTION

It is an object of the present invention to provide novel sulfur-olefin adduct which is used as cross-linking agent in natural and/or synthetic rubber compounding for manufacture of Rubber articles.

It is yet another object of the invention to provide novel sulfur-olefin adduct which exhibits better physical properties in terms of heat stability & product form and easily incorporated in rubber with less fall through during mixing in two roll mill and shows comparable or better properties in terms of dispersion, bloom, dynamic physical properties, & other cure characteristics w.r.t. Insoluble Sulfur.

It is yet another object of the present invention to provide a rubber cross-linking agent such as sulfur-olefin adduct in the form of easily usable product form viz. pastilles or pellets, having a softening or melting point well below the melting temperature of elemental sulfur so that it can be incorporated in rubber at a substantially lower temperature than when elemental sulfur is used.

It is yet another object of the present invention to provide novel sulfur-olefin adduct which can be used as such or on suitable carriers such as carbon, silica, or the like which are conventionally used in rubber compounding.

It is yet another object of the present invention to provide a rubber cross-linking agent such as sulfur-olefin adduct to prevent scorching tendency of the rubber composite before vulcanization and also gain advantage of mixing at relatively lower temperature in conventional mixing devices.

It is still another object of the invention to provide a rubber cross-linking agent which has the bloom-resistant properties compared to Sulfur.

It is yet another object of the invention to provide a novel catalytically controlled polymerization process comprising of reacting sulfur with olefins to form sulfur-olefin adduct which has superior performance & product form, as a crosslinking agent.

It is yet another object of the invention to provide an efficient & industrially scalable process for the production of a sulfur-olefin adduct most likely to exist in the form of sulfur-olefin co-polymer/terpolymer that can serve as a novel crosslinking agent for unsaturated rubbers/elastomer and is economically attractive.

### SUMMARY OF THE INVENTION

According to one aspect of the invention, the present application provides a sulfur-olefin adduct, wherein the adduct comprises of sulfur and polymeric sulfur in the ratio of 1.5:1 to 9:1, characterized in that the said Sulfur-olefin adduct is completely soluble in Carbon disulfide wherein the Sulfur-adduct is characterized by a DSC melt point onset of between about 90 °C to about 100 °C and final melt temperature is less than 110 °C.

According to another aspect of the invention, the present application provides a catalytically controlled suspension polymerization process for preparation of sulfur-olefin adduct by reacting sulfur with aliphatic olefin and/or aromatic olefin or a mixture of olefins in the presence of water, base, dispersing agent and a catalyst in an agitated reactor system to obtain sulfur-olefin adduct, wherein the weight ratios at the start of the reaction of sulfur to olefin(s) is from 5:1 to 9.5:0.5, and weight ratios of water to mixture of sulfur and olefin(s) is from 1.5:1 to 10:1.

According to another aspect of the invention, the present application provides a catalytically-controlled inverse vulcanization process of sulfur, comprising the steps of heating together with agitation at a temperature of more than 100 °C, sulfur and an olefin or mixture of olefins in a basic aqueous reaction media, in the presence a dispersing agent and adding an optimal dosage of catalyst for controlling polymerization of sulfur to form the Sulfur-olefin adduct.

According to another aspect of the invention, the present application provides a catalytically controlled suspension polymerization process for preparation of a sulfur-olefin adduct, wherein the process comprises the below steps;
a. Adding sulfur with olefin or a mixture of olefins in the presence of water, base, dispersing agent and a catalyst in an agitated reactor system
b. Heating the reaction mixture to 120 °C to 200 °C under agitation for at least 2 hours;
c. Cooling and isolating the sulfur-olefin adduct in the powder/granular form;
d. Optionally washing the powder/granular product with suitable solvent to remove the impurities;
e. Optionally Drying the product;
f. Optionally forming pastilles by pastillation or granules by granulation using suitable devices;

According to another aspect of the invention, the present application provides a sulfur-olefin adduct as a free-flowing powder/granular form and is easy to incorporate into rubber vulcanization process to form vulcanized articles useful in tire and non-tire industry.

According to another aspect of the invention, the present application provides a catalytically controlled suspension polymerization process for the preparation of a sulfur-olefin adduct in powder/granular form as cross linking agent for rubber comprising the following process steps:
(a) Reacting sulfur, olefin or a mixture of olefins, water, a base, a dispersing agent and a catalyst in a suitable agitated reactor system under conditions that produce at the end of reaction, a mixture of polymeric sulfur and sulfur, in powder/granular form, easily isolated from the reactor, wherein the weight ratios at the start of the reaction of sulfur to olefin or mixture of olefins is from 5:1 to 9:1, and weight ratios of water to sulfur plus olefin or mixture of olefins is from 2:1 to 10:1;
(b) Heating the reaction mixture to 150 °C to 180 °C under agitation for a period of 4-6 hour time to form the powder/granular crosslinking agent;
(c) Cooling and isolating the sulfur-olefins adduct in the powder/granular form by filtration;
(d) Optionally washing the powder/granular product with water to remove the impurities;
(e) Drying the product;
(f) Forming pastilles by pastillation or granules by granulation using suitable devices;
(g) Using the product so obtained in rubber formulations for a wide variety of rubber articles.

### DESCRIPTION OF THE INVENTION

Sulfur (S₈ Monomer) in a molten state at a temperature above 159 °C undergoes ring-opening polymerization (ROP), resulting in the formation of linear sulfur diradicals which polymerizes into a polymeric form of sulfur namely Insoluble sulfur and soluble sulfur, and their composition depends on reaction temperature, time, and conditions of cooling. Insoluble sulfur in comparison to soluble sulfur, is insoluble in Carbon disulfide (CS₂) or Toluene solvent and hence Insoluble sulfur can be separated from soluble sulfur by solvent extraction.

The production of insoluble sulfur involves hazardous operations involving high temperatures (250 °C to 650 °C) and handling of huge quantities of flammable & hazardous Carbon Disulfide. The process is highly energy intensive & involves lot of safety issues which require high level of process control & automation, adding to the cost of production.

According to one embodiment the present application provides a sulfur-olefin adduct, wherein the adduct comprises of sulfur and polymeric sulfur in the ratio of 1.5:1 to 9:1, characterized in that the said Sulfur-olefin adduct is completely soluble in Carbon disulfide wherein the Sulfur-adduct is characterized by a DSC melt point onset of between about 90 °C to about 100 °C and final melt temperature is less than 110 °C.

According to another embodiment, the present application provides an elegant, novel and safe process for the manufacture of sulfur-olefin adduct which exhibits better physical properties in terms of heat stability & product form and when incorporated in rubber shows comparable or better properties w.r.t. bloom, dynamic physical properties, & other cure characteristics in comparison to Insoluble sulfur and can be efficiently used as cross linking agent in natural and synthetic rubber industry and is economically attractive.

According to another embodiment, the present application provides a rubber cross-linking agent such as sulfur-olefin adduct, in the form of easily usable product form viz. powder, pastilles, or pellets, having a softening or melting point well below the melting temperature of elemental sulfur so that it can be incorporated in rubber at a substantially lower temperature than when only elemental sulfur is used and prevents scorching tendency of the rubber composite before vulcanization and also gain an advantage of mixing at relatively lower temperature in conventional mixing devices.

According to yet another embodiment, the present application provides a rubber cross-linking agent which has bloom-resistant properties compared to rubber grade Sulfur.

According to yet another embodiment, the present application provides a novel catalytically controlled polymerization process comprising of reacting sulfur with olefins to form adduct of sulfur with olefins, which has superior performance & product form, as a crosslinking agent.

According to yet another embodiment, in the present application, Sulfur/olefins reaction product is obtained by suspension polymerization to give a sulfur-olefin adduct composition containing a mixture of polymeric macromolecules and free soluble sulfur which was found thermally stable and which provides properties similar to Insoluble Sulfur during rubber processing. Moreover, the product was found surprisingly to be completely soluble in CS₂. However, toluene solubility of the product varied with the initial sulfur & olefins composition & also the time of polymerization reaction, the soluble component varying from 25% to 99% of the total weight contrary to Insoluble sulfur, which is insoluble in both CS₂ and Toluene.

Thus, the product obtained as per the process described in the present invention and having polymeric sulfur component (being soluble in CS₂ and variably soluble in Toluene) differs from the polymeric form of Insoluble sulfur used in rubber vulcanization. The Toluene soluble component of the product of invention most likely exists in the form of a mixture of oligomeric sulfur-olefin copolymer and amorphous supercooled liquid sulfur which does not show a blooming tendency, besides being in soluble form.

U.S. Pat. No. 4,902,775 discloses, sulfur-olefin adduct containing from about 39% to about 46% by weight of free elemental sulfur as suitable for cross-linking agent in terms of bloom and 300% Modulus. Contrary to this, the novel sulfur-olefin adduct of the present invention though comprise of more than 60% sulfur, more preferably between 70-85% by weight sulfur as analyzed by HPLC, and yet perform better in terms of bloom and Modulus.

According to yet another embodiment, the rubber cross-linking agent as provided in the present invention is in the form of easily usable product form viz. powder, pastilles, or pellets, having a softening or melting point well below the melting temperature of elemental sulfur so that it can be incorporated in rubber at a substantially lower temperature than when elemental sulfur is used, to prevent scorching tendency of the rubber composite before vulcanization and also gain advantage of mixing at relatively lower temperature in conventional mixing devices.

According to yet another embodiment, the rubber cross-linking agent as provided in the present invention has bloom-resistant properties compared to normal Sulfur. According to yet another embodiment, the present invention provides an efficient & industrially scalable process for the production of a sulfur-olefin adduct that can serve as a novel crosslinking agent for unsaturated rubbers and is economically attractive.

According to yet another embodiment, the present application provides a catalytically controlled suspension polymerization process for preparation of sulfur-olefin adduct by reacting sulfur with aliphatic olefin and/or aromatic olefin or a mixture of olefins in the presence of water, base, dispersing agent and a catalyst in an agitated reactor system to obtain sulfur-olefin adduct in a form, wherein the weight ratios at the start of the reaction of sulfur to olefin(s) is from 5:1 to 9.5:0.5, and weight ratios of water to mixture of sulfur and olefin(s) is from 1.5:1 to 10:1. According to yet another embodiment, the novel composition of Sulfur-olefin adduct is prepared by a catalytically controlled inverse vulcanization process in batch or continuous manner comprising the steps of heating together with agitation at a temperature of more than 100 °C, sulfur and an olefin or mixture of olefins in a basic aqueous reaction media in the presence a dispersing agent and adding an optimal dosage of catalyst for controlling polymerization of sulfur to form the Sulfur-olefin adduct.

According to yet another embodiment, the present application provides a catalytically controlled suspension polymerization process for preparation of a sulfur-olefin adduct, wherein the process comprises the below steps;
a. Adding sulfur with olefin or a mixture of olefins in the presence of water, base, dispersing agent and a catalyst in an agitated reactor system
b. Heating the reaction mixture to 120 °C to 200 °C under agitation for at least 2 hours;
c. Cooling and isolating the sulfur-olefin adduct in the powder/granular form;
d. Optionally washing the powder/granular product with suitable solvent to remove the impurities;
e. Optionally Drying the product;
f. Optionally forming pastilles by pastillation or granules by granulation using suitable devices;

According to yet another embodiment, the present application provides a industrially economical suspension polymerization process where sulfur is reacted with an olefin or a mixture of olefins, in an aqueous suspension of a base & a dispersing agent, in presence of an catalyst which catalyze co-polymerization of sulfur with the olefins at temperature between 120 °C & 200 °C, preferably between 160 °C & 180 °C, more preferably 160 °C & 170 °C & hold for a period of 1 to 24 hour and more preferably 3 to 8 hours and most preferably 5 to 6 hours before cooling.

According to yet another embodiment, the present application provides a novel sulfur-olefin adduct which is prepared by suspension polymerization of sulfur and olefins at 160°-170 °C under agitation in water, in presence of a base and a dispersing agent and adding a catalyst within narrow dosage range to control the sulfur polymerization, so as to obtain a product comprising of soluble sulfur & polymeric sulfur-olefin adduct as a free flowing powder/granular product. These surprising properties are achieved through a catalytic suspension polymerization process for sulfur-olefin adduct.

The water along with dispersing agent & a base, serves as a medium in which the sulfur can melt and react with the olefins under effective mixing & adding optimum level of catalyst at a higher temperature>159 °C, under autogenous pressure for a given period of time. When the reaction mixture is cooled, the sulfur-olefin adduct is obtained as small granular or powder form & can be separated by filtration. The water acts as a heat sink for any exothermic reaction and base neutralizes any acidic moiety viz. H₂S which may form in the process. The catalyst controls co-polymerization to give a free flowing polymeric material in powder/granular form. Thus, the present invention provides a novel catalytically controlled polymerization process for preparation of novel sulfur-olefin adduct and which can be easily scaled up to commercial production scale.

According to another aspect of the invention, the present application provides a catalytically controlled suspension polymerization process for the preparation of a sulfur-olefin adduct in powder/granular form as cross linking agent for rubber comprising the following process steps:
(a) Reacting sulfur, olefin or a mixture of olefins, water, a base, a dispersing agent and a catalyst in a suitable agitated reactor system under conditions that produce at the end of reaction, a mixture of polymeric sulfur and sulfur, in powder/granular form, easily isolated from the reactor, wherein the weight ratios at the start of the reaction of sulfur to olefin or mixture of olefins is from 5:1 to 9:1, and weight ratios of water to sulfur plus olefin or mixture of olefins is from 2:1 to 10:1;
(b) Heating the reaction mixture to 150 °C to 180 °C under agitation for a period of 4-6 hour time to form the powder/granular crosslinking agent;
(c) Cooling and isolating the sulfur-olefins adduct in the powder/granular form by filtration;
(d) Optionally washing the powder/granular product with water to remove the impurities;
(e) Drying the product;
(f) Forming pastilles by pastillation or granules by granulation using suitable devices;
(g) Using the product so obtained in rubber formulations for a wide variety of rubber articles.

According to yet another embodiment of the present invention, the sulfur-olefin adduct contains >60% by weight of sulfur as analyzed by HPLC technique.

More specifically, in the present invention sulfur-olefin adduct is characterized by a DSC melt point onset of between 90 °C and 100 °C when measured at a DSC heat rate of 0.5 °C/minute.

Also, the viscosity of the sulfur-olefin adduct obtained from the present invention is higher than that of sulfur when measured at 150 °C. Viscosity of sulfur measured at 150 °C is about 8 cP to 9 cP (centipoise) and the viscosity of the Sulfur-olefin adduct of the present invention is about 35 cP to about 45 cP at 150 °C.

Further Fourier Transform Infrared Spectroscopic (FTIR) studies revealed that Sulfur-olefin adduct obtained from the present invention by using Diffuse Reflectance technique of powder sample, showed distinct IR bands in the region of 1500-2000 cm⁻¹ which are different from both sulfur and also the product obtained as per the method in Example 18 of U.S. Pat. No. 4,902,775.

More specifically, in the present invention sulfur-olefin adduct has lower Dropping point than Sulfur and that of the product obtained from Example 18 of U.S. Pat. No. 4,902,775, which is the closest prior art.

The distinguishing features of the Sulfur-olefin adduct of the present invention in comparison with the product as obtained from Example—18 of U.S. Pat. No. 4,902,775 and with sulfur are described in the following Table-I:

Table-I: Comparative Study of Sulfur-Olefin Adduct of the Present Invention w.r.t. Sulfur and Sulfur-Olefin Adduct from Prior Art (U.S. Pat. No. 4,902,775, Example 18)

| | | Sulfur-Olefin | Sulfur-olefin |
|---|---|---|---|
| | | adduct as per | adduct as |
| | | U.S. Pat. No. | per present |
| | Sulfur | 4,902,775 | invention |
| S % by HPLC | 99% | 41% | 78.4% |
| DSC, melt point | 101 °C | 100 °C | 96.1 °C |
| onset (FIG. I) | | | |
| DSC, Peak (FIG. I) | 117 °C | 105.4 °C | 107.3 °C |
| Viscosity @ 150 °C | 8.5-9 cP | Doesn't melt | ~40 cP |
| | | at 150 °C | |
| FTIR (FIG. II) | No | No | Distinguishing |
| | distinguishing | distinguishing | bands between |
| | band | band | 1500-2000 cm⁻¹ |
| Toluene Extraction | Soluble | 12% soluble | 97% soluble |
| (Soxhlet) | | 88% Insoluble | 3% Insoluble |
| Dropping Point | 120-122 °C | >150 °C | 110-112 °C |
| CS₂-solubility, | 32 | 26 | 36 |
| g/100 g CS₂ | | | |

According to another specific embodiment of the present invention, there is further disclosed a sulfur-olefin adduct, containing from about 25% to about 98% by weight of Toluene soluble component & prepared according to a process which includes the steps of:
i) heating to a temperature from 120 °C to about 200 °C, preferably 160-180 °C and more preferably 160-170 °C, with efficient agitation in an Autoclave under autogenous pressure, an aqueous suspension containing a mixture of sulfur and at least one olefin, or a mixture of olefins, preferably two different olefins along with a base and dispersing agent, and an optimum amount of a catalyst, wherein the aqueous suspension is heated for a time sufficient to form a powder/granular form of the sulfur-olefin adduct; and
ii) Isolating the powder/granular form of sulfur-olefin adduct by filtration, followed by washing with water and drying; and
iii) Optionally making pastilles or pellets of the resulting solid Sulfur-olefins adduct either by melting and pastillating in a suitable pastillation device or in a granulation device.

The product of the present invention, is found to be stable both on long term storage and also on heating to ~105 °C and hence the product comprising of polymeric sulfur-olefin adduct in the form of sulfur-olefins co-polymer/terpolymer and amorphous soluble sulfur, show stabilized properties in comparison to Insoluble sulfur (which reverts to normal soluble sulfur on heating) and thus have significant advantage over both soluble sulfur and insoluble sulfur in rubber processing, preferably in tire manufacturing processes. The addition of vinylic monomers to the molten sulfur acts as a cross-linker, allowing formation of a cross-linked chain with a stable structure.

In another embodiment, there is disclosed a product, in the form of pastilles or pellets made from the melt and/or granulating the powder to obtain a uniform product form for final application in rubber compounding and provide ease of handling in Mixing devices.

The novel inverse vulcanized sulfur-olefin adduct produced according to the present invention comprises of polymers of sulfur and sulfur. Specific olefinic compounds which are useful in the present invention include but are not limited to aliphatic and aromatic olefinic hydrocarbons such as isobutylene isopentene, diisobutylene, triisobutylene; cycloalkenes such as cyclopentene and cyclohexene; unsaturated terpenes such as pinene, Dipentene, camphene, and myrcene; aralkenes such as styrene, dihydronaphthalene, indene, alpha-methyl styrene and polyolefins such as butadiene, isoprene, chloroprene, cyclopentadiene, dicyclopentadiene, cyclohexadiene, vinyl cyclohexene, 1,7-octadiene, cyclooctadiene and the like. The preferred olefinic compounds are styrene, alpha-methyl styrene, cyclopentadiene, and dicyclopentadiene with a combination of styrene and dicyclopentadiene being particularly preferred.

The olefinic reactants to be used are not limited to the specific olefinic reactants mentioned above, but other olefinic reactants, as usually employed by anyone skilled in the art & which form compounds, polymers or copolymers with sulfur will also be useful to form equivalent non-blooming cross-linking agents.

In cases where more than one olefin is employed, the weight ratios of the olefins to each other may vary widely depending on the particular olefins and the desired properties of the sulfur-olefin adduct.

According to one preferred embodiment, the weight ratio of Styrene to Dicyclopentadiene (DCPD) may vary from about 1:1 to about 5:1. In a particularly preferred embodiment, the weight ratio of Styrene to DCPD ranges from about 5:1 to about 1:5, more preferably 9:1 and most preferably 4:1. The weight ratios of the olefins used e.g., Styrene and DCPD, has a bearing on the properties of the Sulfur-olefin curing agent w.r.t. dispersion in rubber. It is found that higher amount of DCPD gives an adduct which is difficult to disperse in rubber matrix.

According to one embodiment, the preferred proportions of water and sulfur is such that the product obtained is freely agitated and suspended in the aqueous reaction mass as a slurry having around 10-40% (weight/weight) w/w slurry concentration, more preferably 15-25% w/w. The water to sulfur weight ratio can be from about 2:1 to 10:1, preferably from 2:1 to 8:1 and most preferably from 2:1 to 6:1.

According to one embodiment, the preferred proportions of sulfur and the olefinic reactants are those which maximize the available sulfur while exhibiting good dispersion characteristics, and just enough of the olefinic reactant is present to prevent blooming.

According to another embodiment, the proportion of sulfur in the sulfur plus olefins mixture is from about 80% to about 95% by weight, preferably from about 85% to 90% by weight and most preferably 90% by weight, for the best performance vis-à-vis incorporation in rubber, dispersion, tensile properties etc., while the proportion of the unsaturated olefins reactant is from about 5% by weight to about 15% by weight with respect to Sulfur, more preferably 10% by weight of sulfur to get both cost & performance advantage.

According to yet another embodiment, the base to be used in the reaction of the sulfur-olefin adduct include but is not limited to, calcium carbonate (CaCO₃), sodium carbonate, Zinc Carbonate, sodium hydroxide, organic amines (e.g. triethylamine (TEA), etc.), and the like. CaCO₃ is most preferable as base being cheap and easily available. According to another embodiment, the weight ratio of the base to sulfur may vary from 1:10 to 1:25. The base has to be used in a proportion such that the pH of the reaction mass is maintained between 7 and 10, more particularly between 8 and 9.

According to yet another embodiment, the catalysts used for “Controlled inverse vulcanization” in the instant invention are from a class of compounds, such as, but not limited to, metal salts of dialkyl dithiocarbamates preferably Zinc-salt of Diethyl dithiocarbamate (ZDC), thiuram disulfides (preferably TMTD), and the like or a mixture of thereof.

According to yet another embodiment, optimum amount of the said catalyst, is in the range of 1-5000 ppm, preferably between 500-5000 ppm and most preferably between 1000-3000 ppm, with respect to total Sulfur plus olefins charge. Very low & very high dosage of the said catalyst leads to a product which is difficult to isolate from the reactor system as it forms big lumps, even though surprisingly exhibits properties in rubber equivalent to the powder/granular product.

According to yet another embodiment, the dispersing agents used in the process of sulfur-olefins copolymerization include but are not limited to polyethylene oxides, fatty alcohol ethoxylates, polysorbates, carboxymethyl cellulose, polyvinyl alcohol, etc. alone or a mixture thereof. The dosage level of dispersing agent(s) is between 0.1% to 10% by weight w.r.t. dosage of sulfur used in the process.

According to yet another embodiment, the sulfur-olefin adduct as cross-linking agent of this invention are prepared at temperatures in the range of from 120 °C to 200 °C and preferably from 140°-170 °C and most preferably, the reaction is conducted at least 160 °C-165 °C. At temperatures below 145 °C, the granular product after isolation agglomerate & form a lumpy mass. The reaction, since it is conducted above the boiling point of water, is necessarily conducted in a pressure reactor system.

According to yet another embodiment, the invention provides a process in which the mother liquor is recycled after suitable treatment, in a manner which makes the process more economical. It is found that the mother liquor can be recycled with minimum top-up of the dispersing agent/s for several recycles before it is purged, which can be easily judged by those skilled in the art.

According to yet another embodiment, this invention discloses an optimum ratio of Sulfur and the olefins, e.g., Styrene & DCPD, temperature & time of reaction, which provides a sulfur-olefin adduct, optionally recycling the mother liquor, such that the process becomes economically attractive for industrial commercial scale.

As another embodiment of the said process, it can be conducted in a batch or a continuous process, by suitable optimization of process parameters, in a manner which is obvious to those skilled in the art.

According to yet another embodiment, the novel sulfur-olefin adduct of the present application can be used as such or supported on suitable carriers such as carbon, silica, or the like which are conventionally used in rubber compounding.

The vulcanizates prepared by sulfur-olefin adduct of the present invention are useful in non-tire rubber compounds, e.g., retread, conveyor belts, cycle tires, hoses, moulded and extruded products, etc. and tire components, such as casing compounds, treads, tire sidewalls, steel belts and apex and wirecoat stocks. Other products which can use this invention include rollers, coloured rubber articles and wherever it is desired to provide a stable elastomer that does not exhibit sulfur bloom and it is found superior in dispersion in rubber w.r.t. Insoluble sulfur.

According to another embodiment, the vulcanization process using the product of the present invention involves preparing a master batch comprising of rubber, carbon black, a vulcanization activator, anti-degradant, and a processing oil in an internal mixer such as Banbury mixer, open Two roll mill i.e., the non-productive stage of mixing and later adding a vulcanization system comprising of polymeric sulfur, and vulcanization accelerators to the master batch on internal mixer such as Banbury, two-roll mill in the productive stage of mixing. After mixing the uncured rubber composition is matured for 24 hours, followed by vulcanization by heating at 140-180 °C for 6 hours, more preferably for 3 hours, e.g., by compression moulding, transfer moulding and injection moulding.

As another embodiment, the product obtained according to the process of the present invention shows better heat & storage stability with respect to Insoluble Sulfur as shown by the evaluation in rubber after subjecting the sulfur-olefin adduct prepared as per the process of the present invention, to a temperature of 105 °C for a period of 8 hour and compared with similar treatment for Insoluble sulfur. The product is found to have better heat stability w.r.t. Insoluble sulfur.

The present invention is also directed to a Sulfur-olefin adduct characterized by a DSC melt point onset between 90 °C, and 100 °C when measured at a DSC heat rate of 0.5 °C/minute. More preferably the DSC melt point onset is between 97 °C, and 100 °C when measured at a DSC heat rate of 0.5 °C/minute, and most preferably the DSC melt point onset is between 98 °C and 100 °C, when measured at a DSC heat rate of 0.5 °C/minute. An important aspect of the Sulfur-olefin adduct of the present invention is that they have unexpectedly been found to exhibit a lower melting point relative to other forms of sulfur (rubber grade and insoluble) and therefore has been identified as a particularly suitable crosslinking agent for Rubber.

In industrial practice of Rubber processing using insoluble sulfur, especially in Tire industry, the productivity, throughput, and processing speed are limited due to requirement of control of processing temperature to less than 100 °C, to avoid reversion of the insoluble sulfur to soluble sulfur, in view of bloom and loss of tack. Hence, the sulfur-olefin adduct of the present invention, which is found to be thermally more stable, provides distinct advantage to maximize productivity in Rubber processing and thereby economically beneficial.

### Analytical Methods:

### Differential Scanning Calorimetry (DSC):

The Differential scanning calorimetry method (DSC) to measure the melt point onset and melting point range of the sulfur-olefin adduct of the present invention involves a first heating scan, from which are determined the melting peak temperature and the exothermic peak temperature. The instrument used was a Mettler-Toledo-DSC-1 Star. The procedure used is described herein as follows. The instrument was calibrated according to the manufacturers “User's Manual”. For sulfur-olefin adduct specimens, a similar method was used. An aluminum pan and lid were tared on a balance. About 6.0-7.0 mg of the sulfur-olefin adduct was weighed into the tared pan, covered with the tared lid, and crimped using a sample crimper. An empty crimped aluminum pan and lid was prepared in a similar fashion as reference. The sample and reference pans were placed in the DSC tray and cell at room temperature. The sample was heated from 50 °C to 130 °C at a rate of 0.5 °C/min in the presence of Nitrogen. “DSC melt point onset” is defined as the temperature at the start of the endothermic melting event. Data analysis was performed using Mettler Stare software-DBV-15.00.

### Dropping Point:

Dropping Point of the Sulfur-olefin adduct was analysed using a Mettler-Toledo DP-70 instrument equipped with a One-Click user interface. Sample was placed in the sample holder, which was placed in the heater. The temperature programming was from 50 °C to 130 °C at a rate of 2 °C/min. The Dropping point was noted when the sample melted and slowly the drop lowered itself in the cell. The Dropping point is automatically displayed by the instrument.

### Fourier Transform Infrared (FTIR) Spectroscopy:

The sulfur-olefin adduct samples were analysed by Diffuse Reflectance Infrared Fourier Transform Spectroscopy technique using Jasco FTIR 4600 and spectrums were compared with reference to elemental sulfur. The sample of adduct was powdered and taken in a sample cup and data is collected on the bulk sample and recorded using Spectra-Manager software.

### Sulfur Content Analysis by HPLC:

The sulfur-olefin adduct was dissolved in THF (25 mg in 25 ml THF) and 20 microliter sample was injected in an Agilent 1260 Infinity-II HPLC, on a Waters Microbondapak C-18 column (10 micron/3.9×300 mm). Detector was a PDA-UV-detector and measurement was done at λ 254 nm. Data analysis was performed using the Agilent CDS-Chemstation software.

External standard method using Sulfur as standard, was used for quantitative analysis and sulfur content in adduct is expressed as % weight/weight (% w/w) of adduct sample taken for HPLC analysis.

Toluene Solubility was determined by Soxhlet Extraction using 10 g (gram) of sample for 24 hours in a Soxhlet Apparatus. The solubility is expressed as weight/weight (w/w) i.e., amount in % weight is soluble in Toluene from initial weight taken.

Solubility in CS₂ was measured by dissolving the sulfur-olefin adduct in CS₂ till saturation at ambient temperature (~30 °C) and expressed as g/100 g CS₂ i.e., amount in gram of adduct soluble in 100 gram of CS₂ solvent.

Viscosity was measured by standard method using a Brookfield Viscometer DV2 LT and expressed in centipoise (cP) at 150 °C.

### Rubber Compounding Method:

Rubber compounding is performed as per well-known method for rubber compounding. A masterbatch of rubber, carbon black, stearic acid, zinc oxide, processing oil, and antidegradant are mixed in an internal mixer (Banbury, dump temperature 140-160 °C). Subsequently, the sulfur-olefin adduct made as per the present inventive process, an accelerator were mixed with the masterbatch on a two-roll mill at 50-90 °C and matured for 24 hour. Rubber compounds were vulcanized by compression moulding at 140 °C for a period of time equal to optimum cure time (t90-Rheometer graph). After cooling the vulcanized sheets were kept for 24 hour and their properties were determined as per ASTM standard methods D412.

The following examples illustrate certain embodiments of the instant invention and are intended to be illustrative only. It is to be understood that numerous changes can be made in the ingredients, proportions and conditions specifically disclosed therein without departing from the spirit of the invention and does not impose limitations to the scope of the present invention.

### EXAMPLES

Comparative Examples 1-3 provides information on Sulfur-Olefin bulk co-polymerization, whereas Comparative Example 4 describes suspension polymerization without catalyst, as given in prior art.

### Comparative Example—1: Reaction of DCPD with Sulfur (Weight Ratio of S:DCPD=91:9) (Reference: Jakub Wręczycki et al. In “Advance in Petroleum and Gas Industry and Petrochemistry” (APGIP-9))

Into a 1000 ml flask equipped with a temperature controller, thermowell and mechanical stirrer were placed 363.6 g of sulfur. The flask was flushed with nitrogen and the mixture was heated to 140 °C. Stirring was started when the sulfur had melted. 36.4 g DCPD was added to the molten Sulfur at 140 °C. The reaction exothermed 165 °C and became too viscous to stir in 25-30 minutes. The product solidified at 165 °C and stuck to the impeller & the thermowell and upon cooling resembled concrete. It was very difficult to remove the reaction product from the flask.

### Comparative Example—2: Reaction of DCPD & Styrene with Sulfur (Weight Ratio of S:DCPD:Styrene=87:8.7:4.3) (Reference: Jakub Wręczycki et al. In “Advance in Petroleum and Gas Industry and Petrochemistry” (APGIP-9))

Into a 1000 ml 4-necked flask equipped with a temperature controller, thermowell and mechanical stirrer were placed 435 g of sulfur, 43.5 g DCPD & 21.5 g Styrene. The flask was flushed with nitrogen and the mixture was heated to 140 °C. Stirring was started when the sulfur had melted. The reaction exothermed to 165 °C and became very viscous to stir in 25-30 minutes. The mass was held at ~140-150 °C for 3 hours. The product became rubbery & solidified and stuck to the impeller & the thermowell. It was very difficult to remove the reaction product from the flask.

### Comparative Example—3: Reaction of DCPD & Styrene with Sulfur in Autoclave (Weight Ratio of S:DCPD:Styrene=87:8.7:4.3)

Into a 1 Lt autoclave equipped with a temperature controller, thermowell and mechanical stirrer were placed 435 g of sulfur, 43.5 g DCPD & 21.5 g Styrene. The mixture was heated to 160 °C. Stirring was started at ~120 °C (when the sulfur had melted). The reaction exothermed to 165 °C and became very viscous to stir in 25-30 minutes. The mass was held at ~160-170 °C for 3 hours. The product became rubbery & solidified and stuck to the impeller & the thermowell. It was very difficult to remove the reaction product from the autoclave.

### Comparative Example—4: Reaction of DCPD & Styrene with Sulfur as Per Prior Art U.S. Pat. No. 4,902,775 Ex-18 (Col 11 Table IV) (Weight Ratio of S:DCPD:Styrene=85:13.5:1.5)

In a 1 Lit autoclave with stirrer, was charged 500 g water, 4 g CaCO₃, 6.4 g CMC, 85 g Sulfur, 13.5 g DCPD, 1.5 g Styrene. The autoclave was boxed-up & heated to 160 °C under agitation. It was held at 160 °C for 5 hours. Then it was cooled under stirring & drained. The powder product was filtered, washed with water & dried. Isolated Sulfur-olefin Product Yield=~90% (weight) as brownish powder. Toluene solubility: 12% w/w (by Soxhlet Extraction) and CS₂ solubility: 38.8 g/100 g CS₂; Sulfur content (~41% by HPLC): DSC: Onset initial −96.9 °C, Peak 99.02 °C, Final: 101.72 °C.

### Present Invention

Ex-1: This example illustrates optimized parameters required for the process. (Weight ratio of S:Styrene:DCPD=90:8:2) In a 1 Lt. autoclave with stirrer, was charged 700 g water, 5.6 g CaCO₃, 8.9 g CMC (carboxy methyl cellulose) or 1.26 g Fatty alcohol ethoxylate, 126 g Sulfur(S), 11.2 g Styrene, 2.8 g DCPD, & required quantity of catalyst. The autoclave was boxed-up & heated to 160 °C under agitation. It was held at 160 °C for 3 to 6 hours under autogenous pressure of 5-7 Kg/Cm². Then it was cooled under stirring & drained. The product was filtered, washed with water & dried. Isolated Yield=97.2% (weight) as brownish yellow granular Sulfur-Olefin adduct as product. The sulfur-olefin adduct contains 76.8 weight % of sulfur by HPLC. DSC showed Melt Point onset at 93.5 and peaks at 102.1 and 106.6 °C and a final melt point at 109.3 °C which is very much different from Insoluble Sulfur & Sulfur (melt point onset 101.7, peaks at 102 & 118 °C and final at 118.4 °C); CS₂ solubility~35.9 g/100 g CS₂ (completely soluble).

The Mother liquor from the preceding batch was used up to 3 cycles after suitable treatment and obtained products similar to that obtained from Ex-1 as above.

### Ex-2: Impact of Catalyst Loading on the Product Formation & Properties

This example illustrates the effect of optimum concentration of the catalyst to be employed for efficient processing of the batch w.r.t. reaction mass handling & isolation of product as powder/granules. The amount of catalyst was varied (ppm w.r.t. weight of S), and batch was conducted by varying catalyst dosage between 0 ppm to 5000 ppm & other charges remaining same as described below.

In a 1 Lit autoclave with a stirrer was charged 700 g water, 5.6 g CaCO₃, 8.9 g CMC, 126 g S, 11.2 g Styrene, 2.8 g DCPD & differing amount of catalyst as per the Table 1. The autoclave was boxed-up & heated to 160 °C under agitation. It was held at 160 °C for 3 hours. Then it was cooled under stirring & drained. The product was filtered, washed with water, and dried.

TABLE 1
Effect of catalyst loading

| Expt | Catalyst | |
|---|---|---|
| No | ppm | Sulfur-olefin Adduct Appearance & Properties |
| 2.1 | 0 | Small hard lumps formed sticking to the stirrer & |
| | | and vessel; had to be manually removed |
| 2.2 | 500 | Small hard lumps formed; not-sticking to vessel; |
| | | had to be manually removed |
| 2.3 | 1000 | Free-flowing powder/granules solid; easily removable |
| | | from vessel |
| 2.4 | 2000 | Free-flowing powder/granules solid; easily removable |
| | | from vessel |
| 2.5 | 3000 | Free-flowing powder/granules solid; easily removable |
| | | from vessel |
| 2.6 | 5000 | Hard lumpy mass; had to be manually removed |

For proper reaction mass draining & isolation of reaction product from the reactor, optimum concentration of catalyst is found to be more than about 1000 ppm & less than 5000 ppm.

### Ex-3: Different Sulfur to Olefin Ratio

Examples 3.1 to 3.6 illustrate the impact of varying the Sulfur to Olefins ratios during suspension polymerization reaction on the batch processing w.r.t. reaction mass draining & product isolation and application in rubber. The autoclave batch was carried out as per the Ex-1, but with varying ratios of Sulfur and olefins as given in Table 2.

TABLE 2
Impact of Sulfur-Olefin ratio on product formation and isolation

| | Sulfur/ | | |
|---|---|---|---|
| Ex- | DCPD/ | Sulfur -Olefin Adduct | |
| No. | styrene | Appearance | Application in rubber |
| 3.1 | 85/13.5/1.5 | Free flowing powder solid; | Dispersion is good; but higher dosag [symbol] |
| | | easily removable from vessel | required for obtaining torque equivale [symbol] |
| | | | to Insoluble Sulfur |
| 3.2 | 87/8.7/4.3 | Free flowing powder solid; | Poor dispersion in rubber |
| | | easily removable from vessel | |
| 3.3 | 90/6.7/3.3 | Free flowing powder solid; | Inconsistent torque results w.r.t. |
| | | easily removable from vessel | Insoluble Sulfur |
| 3.4 | 90/9/1 | Free flowing powder solid; | Difficult to disperse in rubber. |
| | | easily removable from vessel | |
| 3.5 | 90/8/2 | Free flowing powder solid; | Poor dispersion in rubber. |
| | | easily removable from vessel | |
| 3.6 | 90/2/8 | Free-flowing powder solid; | Dispersion is good in rubber. |
| | | easily removable from vessel | |

[symbol]

indicates data missing or illegible when filed

### Ex-4: This Example Illustrates the Results Obtained from a Pilot-Scale Reaction of the Process. (Weight Ratio of S:Styrene:DCPD=90:8:2)

Ex-4-(A): In a 40 Lit autoclave with a stirrer, was charged 24.5 liters water, 350 g CaCO₃, 150 g Fatty alcohol ethoxylate, 8000 g Sulfur, 178.4 g DCPD, 710.4 g Styrene & required quantity of catalyst. The autoclave was boxed up & heated to 160 °C under agitation. It was held at 160 °C for 6 hours under autogenous pressure of 6-7 Kg/Cm². Then it was cooled under stirring & drained. The product was filtered, washed with water & dried. Isolated Yield=98.5% as brownish yellow powdery granular product.

This product showed ~98% toluene soluble component (estimated by Soxhlet extraction by toluene); DSC showed onset melt at 94.8 °C and two peaks 101.2 and 106.4 °C and final melt at 107.6 °C which is very much different from Insoluble Sulfur & Sulfur. CS₂ solubility: 35.86 g/100 g CS₂ and sulfur content 78.5 w/w % by HPLC.

Ex-4 (B): In a 40 Lit autoclave with stirrer, was charged 28 liters water, 224 g CaCO₃, 100.8 g Fatty alcohol ethoxylate, 5040 g Sulfur, 112 g DCPD, 448 g Styrene & required quantity of catalyst. The autoclave was boxed-up & heated to 160 °C under agitation. It was held at 160 °C for 6 hours under autogenous pressure of 6-7 Kg/Cm². Then it was cooled under stirring & drained. The product was filtered, washed with water & dried. Isolated Yield=98.5% (wt) as brownish yellow powdery granular product.

This product showed ~64-66% toluene soluble component (estimated by Soxhlet extraction by toluene); DSC showed onset melt at 96.1 °C and two peaks 102.3 and 107.3 °C and final melt at 109.7 °C which is very much different from Insoluble Sulfur & Sulfur. CS₂ solubility~36.01 g/100 g CS₂ and Sulfur content: 78.4% w/w by HPLC.

### Ex-5: Performance in Rubber

Product obtained from the optimized process as per the Ex-4 (A) was taken for product performance in natural rubber (NR) compound along with Control-1 with Sulfur(S) & Control-2 with Insoluble Sulfur (I.S.). One compound using the Ex-4 (A) product was prepared considering active sulfur at 90% concentration. The compounding as per Table-3 and performance evaluation results are summarized in Table-4.

TABLE 3
Rubber compounding details

| | | Insoluble | Ex-4 |
|---|---|---|---|
| Base Recipe | Sulfur | Sulfur | (A) |
| NR | 100 | 100 | 100 |
| Zinc Oxide | 5 | 5 | 5 |
| Stearic Acid | 2 | 2 | 2 |
| TDQ | 1 | 1 | 1 |
| PF Resin | 4 | 4 | 4 |
| N 550 | 27 | 27 | 27 |
| Naphthenic Oil | 6 | 6 | 6 |
| Master Total | 145 | 145 | 145 |
| CBS | 0.7 | 0.7 | 0.7 |
| Sulfur (100%) | 2.4 | — | — |
| OT Sulphur | — | 3 | — |
| (Insoluble Sulfur-80% Active S) | | | |
| Ex-4 (A) | — | — | 2.7 |
| (Present invention 90% Active S) | | | |
| Final Total | 148.1 | 148.7 | 148.4 |

TABLE 4
Performance evaluation data

| | | | | Comparison of |
|---|---|---|---|---|
| | | Insoluble | Ex-4 | Ex-4(A) with |
| Compound Code: | Sulfur | Sulfur | (A) | Insoluble Sulfur |
| Mooney Viscosity (ASTM D 1646): Temp-100 °C-Final Batch | | | | Ex-4 (A) shows |
| ML (1 + 4)-Final | 75.1 | 76.2 | 72.4 | lower Mooney |
| Mooney Scorch (ASTM D 1646): Temp-135 °C | | | | viscosity at 100 °C |
| t5, min. | 12.39 | 10.56 | 9.98 | and comparable at |
| | | | | 135 °C. |
| Rheometric Test: MDR (ASTM D 5289), Arc −0.5°, | | | | |
| Temperature: 140 °C × 30 mins | | | | |
| Minimum Torque, dN-m, | 1.32 | 1.33 | 1.25 | |
| Maximum Torque, dN-m, | 11.75 | 11.37 | 11.22 | |
| (Maximum − Minimum) | 10.43 | 10.04 | 9.98 | Physical properties |
| Torque, dN-m, | | | | are comparable |
| Scorch Time, ts2, minute | 9.94 | 9.2 | 8.58 | Restricted flow in |
| | | | | the mould can be |
| | | | | envisaged |
| Optimum Cure Time, Tc 90, | 21.66 | 20.54 | 19.59 | Comparable |
| minute | | | | |
| Unaged Stress-Strain Properties (ASTM D 412), Cure: 140 °C × OCT minute | | | | |
| 100% Modulus, Mpa | 3.25 | 2.75 | 2.86 | Physical properties |
| 300% Modulus, Mpa | 6.7 | 6.65 | 6.7 | are comparable |
| Tensile Strength, Mpa | 26.5 | 24 | 25.8 | |
| Elongation at Break, % | 600 | 560 | 588 | |
| Hardness, Shore A | 50 | 50 | 50 | |
| Angle Tear, kg/cm | 46.5 | 50.5 | 48.2 | |
| Specific Gravity | 1.06 | 1.064 | 1.063 | |
| Aerobic Aged Stress-Strain Properties (ASTM D 412), | | | | |
| Condition: 85 °C × 96 hours. | | | | |
| 100% Modulus, Mpa, Aged | 2.7 | 2.6 | 2.71 | Aged properties are |
| 300% Modulus, Mpa, Aged | 7.9 | 7.65 | 7.62 | comparable |
| Tensile Strength, Mpa, Aged | 22 | 22 | 22.6 | |
| Elongation at Break, %, Aged | 545 | 540 | 556 | |
| Hardness Shore A, Aged | 52 | 52 | 52 | |
| Din Abrasion (D5963-04): Cure: 150 °C × Optimum Cure Time | | | | |
| Abrasion Loss in mm3 | 102 | 129 | 128 | Comparable |

As can be seen from Table-4 it is clear that the vulcanizate properties of sulfur-olefin adduct from Ex-4 (A), especially at 90% Sulfur consideration, is comparable with or in some cases better than the Insoluble Sulfur. There was no blooming observed in unvulcanized test samples containing the sulfur-olefin adduct from Ex-4 (A), even after storage of 60 days in comparison with Insoluble sulfur.

### Ex-6: Performance in Rubber

Sulfur-Olefin adduct Products obtained from various combinations, viz. Prior Art (Comparative Ex-4), & Ex-3.5 (higher DCPD ratio) along with Control-1 with Sulfur(S) & Control-2 with Insoluble Sulfur (I.S.). The compounding is as per Table-5 and performance evaluation results in Table-6.

TABLE 5
Rubber Compounding Details for Different Sulfur-Olefin Adducts.

| | | Insoluble | Comparative | |
|---|---|---|---|---|
| Base Recipe | Sulfur | Sulfur | Ex-4 | Ex-3.5 |
| NR | 100.00 | 100.00 | 100.00 | 100.00 |
| Zinc Oxide | 5.00 | 5.00 | 5.00 | 5.00 |
| Stearic Acid | 2.00 | 2.00 | 2.00 | 2.00 |
| TDQ | 1.00 | 1.00 | 1.00 | 1.00 |
| PF Resin | 4.00 | 4.00 | 4.00 | 4.00 |
| N 550 | 27.00 | 27.00 | 27.00 | 27.00 |
| Naphthenic Oil | 6.00 | 6.00 | 6.00 | 6.00 |
| Master Total | 145.00 | 145.00 | 145.00 | 145.00 |
| CBS | 0.70 | 0.70 | 0.70 | 0.70 |
| Sulfur | 2.40 | — | | — |
| Insoluble Sulfur | — | 3.00 | — | — |
| Comparative-Ex-4 | — | — | 3.00 | — |
| Ex-3.5 | — | — | — | 3.00 |
| Total | 148.10 | 148.70 | 148.70 | 148.70 |

TABLE 6
Performance Evaluation Results

| | | | |
|---|---|---|---|
| | Insoluble | Comparative | |
| Sulfur | Sulfur | Ex-4 | Ex-3.5 |

Mooney Viscosity (ASTM D 1646): Temp-100 °C-Final Batch

| | | | | |
|---|---|---|---|---|
| Initial Viscosity, units | 50.6 | 53.0 | 58.2 | 46.1 |
| ML (1 + 4)-Final | 33.9 | 35.4 | 35.3 | 29.4 |

Mooney Scorch (ASTM D 1646): Temp-121 °C

| | | | | |
|---|---|---|---|---|
| Initial Viscosity, units | 35.77 | 36.94 | 31.24 | 38.91 |
| Minimum Viscosity, units | 25.2 | 26.8 | 22.03 | 26.6 |
| t5, min. | 29.7 | 26.5 | 27.24 | 25.9 |
| t35, min. | 32.6 | 28.7 | 29.53 | 28.7 |
| t35 − t5, min. | 2.93 | 2.14 | 2.29 | 2.81 |
| Initial Viscosity, units | 33.9 | 32.7 | 34.3 | 29.0 |
| Minimum Viscosity, units | 21.7 | 23.6 | 24.1 | 20.3 |
| t5, min. | 12.2 | 9.7 | 10.2 | 11.2 |
| t35, min. | 13.6 | 11.2 | 11.8 | 12.7 |
| t35 − t5, min. | 1.46 | 1.46 | 1.59 | 1.41 |

Rheometric Test: MDR (ASTM D 5289), Arc −0.5°, Temp-150 °C × 30 mins

| | | | | |
|---|---|---|---|---|
| Minimum Torque, dN-m, | 1.00 | 1.02 | 0.84 | 1.03 |
| Maximum Torque, dN-m, | 12.68 | 12.29 | 10.84 | 7.84 |
| (Maximum − Minimum) Torque, dN-m, | 11.68 | 11.27 | 10.00 | 6.81 |
| Scorch Time, ts1, minute | 3.78 | 3.35 | 3.65 | 5.13 |
| Scorch Time, ts2, minute | 4.14 | 3.70 | 4.07 | 6.40 |
| Time to 50% cure: Tc 50, minute | 5.87 | 5.27 | 5.55 | 8.35 |
| Time to 80% cure: Tc 80, minute | 8.99 | 8.18 | 8.30 | 13.59 |
| Optimum Cure Time, Tc 90, minute | 11.19 | 10.20 | 10.21 | 17.48 |
| Time to 100% cure: Tc 100, minute | 19.02 | 17.49 | 17.79 | 29.95 |
| Cure Rate: (Tc 90 − ts2), min | 7.05 | 6.50 | 6.14 | 11.08 |

Rheometric Test: ODR (ASTM D 2084), Arc −3°, Temp-140 °C × 60 mins

| | | | | |
|---|---|---|---|---|
| Minimum Torque, dN-m, | 8.65 | 8.82 | 6.93 | 8.67 |
| Maximum Torque, dN-m, | 75.03 | 74.03 | 64.43 | 50.68 |
| (Maximum − Minimum) Torque, dN-m, | 66.38 | 65.21 | 57.50 | 42.01 |
| Scorch Time, ts1, minute | 5.54 | 4.47 | 4.90 | 4.88 |
| Scorch Time, ts2, minute | 5.96 | 4.89 | 5.28 | 5.67 |
| Time to 50% cure: Tc 50, minute | 9.18 | 7.80 | 7.97 | 10.63 |
| Time to 80% cure: Tc 80, minute | 12.91 | 11.52 | 10.96 | 16.13 |
| Optimum Cure Time, Tc 90, minute | 15.69 | 12.38 | 13.18 | 20.27 |
| Time to 100% cure: Tc 100, minute | 26.26 | 25.23 | 24.41 | 30.05 |
| Cure Rate: 100/(Tc 90 − ts2), min | 9.73 | 7.49 | 7.90 | 14.60 |

Unaged Stress-Strain Properties (ASTM D 412)
Cure: 150 °C × OCT minute

| | | | | |
|---|---|---|---|---|
| 100% Modulus, Mpa | 2.00 | 1.92 | 1.82 | 1.53 |
| 200% Modulus, Mpa | 4.37 | 4.11 | 3.83 | 3.20 |
| 300% Modulus, Mpa | 7.73 | 7.30 | 6.67 | 5.60 |
| Tensile Strength, Mpa | 22.8 | 22.3 | 23.0 | 7.86 |
| Elongation at Break, % | 570 | 575 | 605 | 375 |
| Hardness, Shore A (ASTM D 2240) | 56 | 57 | 54 | 55 |
| Angle Tear, kg/cm | 50 | 42 | 34 | 30 |
| Sp.gravity | 1.052 | 1.053 | 1.052 | 1.050 |

Aged Stress-Strain Properties (ASTM D 412)
Condition: 85 °C × 96 hours.

| | | | | |
|---|---|---|---|---|
| 100% Modulus, Mpa | 2.75 | 2.67 | 2.25 | 2.05 |
| 200% Modulus, Mpa | 6.45 | 6.36 | 5.72 | — |
| 300% Modulus, Mpa | 11.10 | 10.10 | 9.10 | — |
| Tensile Strength, Mpa | 20.80 | 19.00 | 19.35 | 3.08 |
| Elongation at Break, % | 470.00 | 450.00 | 480.00 | 165.00 |
| Hardness, Shore A (ASTM D 2240) | 58.00 | 58.00 | 57.00 | 56.00 |
| Change in 100% Modulus, % | 137.50 | 139.28 | 123.97 | 133.99 |
| Change in 200% Modulus, % | 147.60 | 154.63 | 149.27 | — |
| Change in 300% Modulus, % | 143.69 | 138.36 | 136.35 | — |
| Retention Tensile Strength, % | 91.05 | 85.11 | 84.13 | 39.21 |
| Retention in Elongation at Break, % | 82.46 | 78.26 | 79.34 | 44.00 |
| Change in hardness | 2.00 | 1.00 | 3.00 | 1.00 |

Din Abrasion (D5963-04): Cure: 150 °C/OCT minute

| | | | | |
|---|---|---|---|---|
| Abrasion Loss in mm3 | 158 | 155 | 129 | 128 |
| Abrasion Index, % | 72 | 73 | 88 | 88 |

Fatigue to Failure: (ASTM D 4482-11)

| | | | | |
|---|---|---|---|---|
| Unaged, kc | 114 | 90 | 91 | 21 |
| Aged: Kc-85 °C × 96 hours. | 69 | 95 | 80 | — |

Goodrich HBU: (ASTM D 623-07), Stroke: 5.71; Load (N): 245

| | | | | |
|---|---|---|---|---|
| Delta Temperature | 6.00 | 4.30 | 21.00 | 5.20 |

As seen from the above Table-6, it is clear that the product with higher DCPD in the reaction leads to a product which is not uniformly dispersed & hence does not show the desired performance in all parameters.

Also, the product from Comparative Ex-4 (Goodyear U.S. Pat. No. 4,902,775) shows relatively less 300% modulus properties compared to that of the product obtained from the present invention

### Ex-7: Heat and Storage Stability Study

To establish heat stability of the sulfur-olefin co-polymer obtained from the present invention vis-à-vis Insoluble sulfur, the material from Ex-4 (A) was kept in oven at 105 °C for 8 hours along with Insoluble sulfur (Table-7). After 8 hours both were removed and allowed to cool to ambient temperature. Both were evaluated in rubber as per the ASTM methods (Table-8). Product prepared as per the Ex-4 (A), stored for 90 days was evaluated in rubber for storage stability (Table-9) of the product of the present invention and the properties compared with insoluble sulfur. Also, the DSC and CS₂ solubility were measured and compared with before heat-treated materials (Table-7)

TABLE 7
Heat stability comparison of Ex-4(A) with Insoluble sulfur

| | Insoluble Sulfur | | Ex-4 (A) | |
|---|---|---|---|---|
| | | Heat treated | | Heat treated |
| | As such | (105 °C/8 hours) | As such | (105 °C/8 hours) |
| CS2 solubility | <3% | >95%; converts | 24.50% | 24.80% |
| | | to Sulfur | | |
| DSC,°C | 1 peak | 2 peaks | 2 peaks | 2 peaks |
| Initial | 106.1 | 104.2 | 94.8 | 94.8 |
| Peak | 108.3 | 105.7 | 101.2 | 101.2 |
| Final | 109.6 | 107.2 | 102.7 | 102.7 |
| Initial | | 117.46 | 103.7 | 103.7 |
| Peak | | 118.59 | 106.4 | 106 |
| Final | | 119.6 | 107.6 | 107.6 |

| | | |
|---|---|---|
| Incorporation in | Slow & fall through | No change (faster than |
| Rubber | observed | Insoluble sulfur) & |
| | | less fall through |
| Bloom (10 days) | No | No |
| Rheometer Data | | |
| Scorch Safety | Safety increases, | No change |
| | similar to Sulfur | |
| Optimum Cure | Tends to become | No change |
| time | slow cure | |
| Cross Link | No change | No change |
| Density | | |
| Mooney | Decreases | Decreases |
| Viscosity | | |
| Elongation at | No change | Slight increase |
| break | | |

TABLE 8
Evaluation of Ex-4(A) before and after heating for 8 hr at 105 °C and
comparison with insoluble sulfur

| | Insoluble | Insoluble Sulfur | | Ex-4-A |
|---|---|---|---|---|
| Base Recipe | Sulfur | (105 °C/8 hours) | Ex-4-A | (105 °C/8hours) |
| NR | 100.00 | 100.00 | 100.00 | 100.00 |
| Zinc Oxide | 5.00 | 5.00 | 5.00 | 5.00 |
| Stearic Acid | 2.00 | 2.00 | 2.00 | 2.00 |
| TDQ | 1.00 | 1.00 | 1.00 | 1.00 |
| PF Resin | 4.00 | 4.00 | 4.00 | 4.00 |
| N 550 | 27.00 | 27.00 | 27.00 | 27.00 |
| Naphthenic Oil | 6.00 | 6.00 | 6.00 | 6.00 |
| Master Total | 145.00 | 145.00 | 145.00 | 145.00 |
| CBS | 0.70 | 0.70 | 0.70 | 0.70 |
| Sulphur | — | — | — | — |
| OT Sulphur | 3.00 | 3.00 | — | — |
| Ex-4(A) | — | — | 2.70 | — |
| Ex-4(A) 105 °C/8 Hrs) | — | — | — | 2.70 |
| Final Total | 148.70 | 148.70 | 148.40 | 148.40 |

Mooney Viscosity (ASTM D 1646): Temp-100 °C-Final Batch

| | | | | |
|---|---|---|---|---|
| ML (1 + 4)-Final | 41.2 | 35.8 | 48.8 | 36.5 |
| Mooney Scorch (ASTM D 1646): | | | | |
| Temp-135 °C | | | | |
| t5, min. | 11.1 | 16.5 | 11.3 | 12.5 |

Rheometric Test: MDR (ASTM D 5289), Arc −0.5°, Temp-140 °C × 30 mins

| | | | | |
|---|---|---|---|---|
| Minimum Torque, dN-m, | 1.45 | 1.27 | 1.85 | 1.33 |
| Maximum Torque, dN-m, | 11.72 | 11.07 | 11.87 | 10.93 |
| (Maximum − Minimum) Torque, dN-m, | 10.27 | 9.80 | 10.02 | 9.60 |
| Scorch Time, ts2, minute | 8.73 | 11.66 | 9.80 | 9.37 |
| Optimum Cure Time, Tc 90, minute | 19.71 | 23.19 | 20.45 | 19.53 |

Unaged Stress-Strain Properties (ASTM D 412)
Cure: 140 °C × OCT minute

| | | | | |
|---|---|---|---|---|
| 100% Modulus, Mpa | 1.80 | 1.60 | 1.80 | 1.70 |
| 300% Modulus, Mpa | 7.40 | 6.25 | 7.20 | 6.55 |
| Tensile Strength, Mpa | 25.0 | 24.5 | 25.0 | 25.0 |
| Elongation at Break, % | 560 | 560 | 555 | 575 |
| Hardness, Shore A | 52 | 52 | 52 | 52 |
| Angle Tear, kg/cm | 55 | 50 | 50 | 50 |

Aerobic Aged Stress-Strain Properties (ASTM D 412)

| | | | | |
|---|---|---|---|---|
| Condition: 85 °C × 96 hrs (4 days). | | | | |
| 100% Modulus, Mpa, Aged | 2.30 | 2.00 | 2.50 | 2.00 |
| 300% Modulus, Mpa, Aged | 10.5 | 8.85 | 10.00 | 8.50 |
| Tensile Strength, Mpa, Aged | 22.0 | 22.0 | 22.5 | 22.5 |
| Elongation at Break, %, Aged | 460 | 515 | 465 | 520 |
| Hardness Shore A, Aged | 55 | 55 | 55 | 55 |
| Change in 100% Modulus, % | 128 | 125 | 139 | 118 |
| Change in 300% Modulus, % | 142 | 142 | 139 | 130 |
| Retention in Tensile Strength, % | 88 | 90 | 90 | 90 |
| Retention in Elongation at Break, % | 82 | 92 | 84 | 90 |
| Change in Hardness, units | 3 | 3 | 3 | 3 |

Din Abrasion (D5963-04): Cure: 150 °C/OCT minute

| | | | | |
|---|---|---|---|---|
| Abrasion Loss in mm3 | 133 | 144 | 109 | 103 |
| Fatigue to Failure Test (D4482-11): | | | | |
| Extension: 1.8 % | | | | |
| Unaged, KC | 164 | 151 | 150 | 146 |
| Goodrich Flexometer | | | | |
| Delta T °C | 5.5 | 4.0 | 3.2 | 3.8 |

TABLE 9
Storage stability study

| | Fresh | | After 90 days | |
|---|---|---|---|---|
| | Insoluble | Ex-4 | Insoluble | Ex-4 |
| Compound Code: | sulfur | (A) | sulfur | (A) |
| Mooney Viscosity (ASTM D 1646): | | | | |
| Temp-100 °C-Final Batch | | | | |
| ML (1 + 4)-Final | 35.4 | 35.3 | 76.2 | 71.6 |
| Mooney Scorch (ASTM D 1646): | | | | |
| Temp-135 °C | | | | |
| t5, min. | 9.7 | 10.2 | 10.56 | 10.17 |
| Rheometric Test: MDR (ASTM D 5289), | | | | |
| Arc −0.5°, Temperature: 140 °C × 30 mins | | | | |
| Minimum Torque, dN-m, | 1.02 | 0.84 | 1.33 | 1.22 |
| Maximum Torque, dN-m, | 12.29 | 10.84 | 11.37 | 11.37 |
| (Maximum − Minimum) Torque, dN-m, | 11.27 | 10.00 | 10.04 | 10.15 |
| Scorch Time, ts2, minute | 3.70 | 4.07 | 9.2 | 8.74 |
| Optimum Cure Time, Tc 90, minute | 10.20 | 10.21 | 20.54 | 20.04 |
| Elongation at Break, %, Aged | 450 | 480 | 540 | 555 |
| Hardness Shore A, Aged | 58 | 57 | 52 | 52 |
| Din Abrasion (D5963-04): | | | | |
| Cure: 150 °C × Optimum Cure Time | | | | |
| Abrasion Loss in mm3 | 165 | 296 | 129 | 131 |

From the above Table-9 it is clear that the product of the present invention is stable (for 90 days) & the dynamic physical properties in rubber are comparable to those obtained with insoluble sulfur.
Figure I: Comparative DSC Study of Normal Sulfur, Sulfur-olefin Adduct as per U.S. Pat. No. 4,902,775 and Sulfur-olefin Adduct of the present invention.
Figure II: Comparative FTIR spectrum by Diffuse Reflection Technique for Normal Sulfur, Sulfur-olefin Adduct as per U.S. Pat. No. 4,902,775 and Sulfur-olefin Adduct of the present invention.

1. A sulfur-olefin adduct wherein the adduct comprises of sulfur and polymeric sulfur in the ratio of 1.5:1 to 9:1, characterized in that the said Sulfur-olefin adduct is completely soluble in Carbon disulfide wherein the Sulfur-adduct is characterized by a DSC melt point onset of between about 90 °C to about 100 °C and final melt temperature is less than 110 °C.

2. The sulfur-olefin adduct as claimed in claim 1, wherein the polymeric sulfur is obtained by reacting Sulfur with olefin(s) and wherein the reactants Sulfur to olefin(s) is in the weight ratio of 5:1 to 9.5:0.5.

3. The sulfur-olefin adduct as claimed in claim 1, wherein the sulfur-olefin adduct is soluble in Toluene in the range of 25-99%, depending on process parameter and mole ratio of reactants.

4. The sulfur-olefin adduct as claimed in claim 1 wherein the olefin is selected from isobutylene isopentene, diisobutylene, triisobutylene; cycloalkene such as cyclopentene and cyclohexene; unsaturated terpenes such as Dipentene, pinene, camphene, and myrcene; aralkenes such as styrene, divinylbenzene, dihydronaphthalene, indene, alpha-methyl styrene and polyolefins such as butadiene, isoprene, chloroprene, cyclopentadiene, dicyclopentadiene, cyclohexadiene, vinyl cyclohexene, 1,7-octadiene, cyclooctadiene or mixture thereof.

5. The sulfur-olefin adduct as claimed in claim 1, wherein the olefinic compounds are aromatic olefin selected from styrene, alpha-methyl styrene and aliphatic olefin selected from Cyclopentadiene, Dipentene and Dicyclopentadiene or mixture thereof.

6. The sulfur-olefin adduct as claimed in claim 5, wherein the weight ratio between the aromatic olefin to aliphatic olefin is in the range of 1:1 to 10:1 preferably 1:1 to 4:1.

7. The sulfur-olefin adduct as claimed in claim 5, wherein the aliphatic olefin is dicyclopentadiene and aromatic olefin is styrene.

8. A catalytically controlled suspension polymerization process for preparation of sulfur-olefin adduct by reacting sulfur with aliphatic olefin and/or aromatic olefin or a mixture of olefins in the presence of water, base, dispersing agent and a catalyst in an agitated reactor system to obtain sulfur-olefin adduct in a form, wherein the weight ratios at the start of the reaction of sulfur to olefin(s) is from 5:1 to 9.5:0.5, and weight ratios of water to mixture of sulfur and olefin(s) is from 1.5:1 to 10:1.

9. A catalytically controlled suspension polymerization process for preparation of a sulfur-olefin adduct as claimed in claim 8, wherein the weight ratio of aromatic olefin to aliphatic olefin is 1:1 to 10:1 preferably in the range of 1:1 to 4:1.

10. A catalytically controlled suspension polymerization process for preparation of a sulfur-olefin adduct as claimed in claim 8, wherein the process comprises the below steps;
a. Adding sulfur with olefin or a mixture of olefins in the presence of water, base, dispersing agent and a catalyst in an agitated reactor system
b. Heating the reaction mixture to 120 °C to 200 °C under agitation for at least 2 hours;
c. Cooling and isolating the sulfur-olefin adduct in the powder/granular form;
d. Optionally washing the powder/granular product with suitable solvent to remove the impurities;
e. Optionally Drying the product;
f. Optionally forming pastilles by pastillation or granules by granulation using suitable devices;

11. The process as claimed in claim 8, wherein the base is selected from the group comprising of inorganic and organic bases including alkali metal carbonates, alkaline earth metal carbonates, alkali metal hydroxides, tetra alkyl ammonium hydroxides, tertiary amines, primary amines, secondary amines.

12. The process as claimed in claim 11, wherein the base is selected from the group comprising of calcium carbonate, sodium carbonate, sodium hydroxide, triethylamine, and/or mixtures thereof.

13. The process as claimed in claim 8, wherein the dispersing agent is selected from the group comprising of fatty alcohol ethoxylates, carboxymethyl cellulose, polysorbates, anionic Tri styryl phenol phosphates or a mixture thereof.

14. The process as claimed in claim 8, wherein the catalyst is selected from the group comprising of metal salts of dialkyl dithiocarbamates, thiuram disulfides, or a mixture thereof.

15. The process as claimed in claim 14, wherein the amount of catalyst or mixture of catalysts is between 500 ppm and 5000 ppm w.r.t. sulfur.

16. The process as claimed in claim 8, wherein the aqueous suspension is heated at a temperature of from about 125 °C to about 180 °C for a reaction time of from about 1 to 24 hours, more preferably 1 to 8 hours and most preferably 5-6 hours.

17. The process as claimed in claim 16, wherein the aqueous suspension is heated at a temperature of about 150 °C to 170 °C for a reaction time of 5 to 6 hours.

18. The process as claimed in claim 8, wherein the mother liquor obtained after solid liquid separation, is recycled in the main reaction of sulfur and olefin, after optionally adopting suitable purification steps.

19. A catalytically controlled suspension polymerization process for the preparation of a sulfur-olefin adduct in powder/granular form as cross linking agent for rubber comprising the following process steps:
(a) Reacting sulfur, olefin or a mixture of olefins, water, a base, a dispersing agent and a catalyst in a suitable agitated reactor system under conditions that produce at the end of reaction, a mixture of polymeric sulfur and sulfur, in powder/granular form, easily isolated from the reactor, wherein the weight ratios at the start of the reaction of sulfur to olefin or mixture of olefins is from 5:1 to 9:1, and weight ratios of water to sulfur plus olefin or mixture of olefins is from 2:1 to 10:1;
(b) Heating the reaction mixture to 150 °C to 180 °C under agitation for a period of 4-6 hour time to form the powder/granular crosslinking agent;
(c) Cooling and isolating the sulfur-olefins adduct in the powder/granular form by filtration;
(d) Optionally washing the powder/granular product with water to remove the impurities;
(e) Drying the product;
(f) Forming pastilles by pastillation or granules by granulation using suitable devices;
(g) Using the product so obtained in rubber formulations for a wide variety of rubber articles.

20. The sulfur-olefin adduct as claimed in claim 1, used as such or on carriers such as carbon black, silica or mixtures thereof, for rubber formulation.
